(19) United States
(12) Patent Application Publication
(10) Pub. No.: US 2011/0205167 A1
(43) Pub. Date: Aug. 25, 2011

(54) Brain concussion screening method & apparatus

(75) Inventor: R. Kemp Massengill, Leucadia, CA (US)

(73) Assignee: Massengill Family Trust, Leucadia, CA (US)

(21) Appl. No.: 12/931,881

(22) Filed: Feb. 12, 2011

Related U.S. Application Data
(63) Continuation-in-part of application No. 12/157,327, filed on Jun. 9, 2008.
(60) Provisional application No. 60/934,459, filed on Jun. 13, 2007.
(60) Provisional application No. 60/936,288, filed on Jun. 18, 2007.

(51) Int. Cl. G09G 5/00; G06F 3/041

(52) U.S. Cl. 345/173; 345/156

(57) ABSTRACT

A method and apparatus for detecting a reduction in cerebral function of an athlete, indicating the incidence of a brain concussion, by displaying a moving icon on a screen, and asking the athlete to track the movements of the icon, by following it either with the eyes or by touching a touch screen. The icon can be displayed on a device fixedly positioned relative to the head of the athlete, or on an interactive touch screen display. The athlete's performance is tested in real time, soon after the possible incidence of a concussion. The performance of the athlete can be compared to that particular person's history of test results, or to a data base of test results of other test subjects. Control of the display, tracking of the athlete's gaze or touch, and analysis of the test results, can all be performed by a computer.

### CROSS REFERENCE TO RELATED APPLICATIONS

This is a continuation-in-part patent application of co-pending U.S. patent application Ser. No. 12/157,327, filed on Jun. 9, 2008, and entitled “Alertness Testing Method and Apparatus,” which claims the benefit of U.S. Provisional Patent Application No. 60/934,459, filed on Jun. 13, 2007, and entitled “Alertness Tester Method and Apparatus,” and which also claims the benefit of U.S. Provisional Patent Application No. 60/936,288, filed on Jun. 18, 2007, and entitled “Alertness Tester for Detecting Impaired Motorists.”

### STATEMENT REGARDING FEDERALLY SPONSORED RESEARCH OR DEVELOPMENT

Not Applicable

### BACKGROUND OF THE INVENTION

1. Field of the Invention

This invention is in the field of methods and apparatus used in the testing of athletes in real-time, soon after the possible incidence of a brain concussion or other brain injury, to determine whether such a brain injury has occurred.

2. Background Art

Athletic competitions seek the highest levels of performance, if success is to be achieved. Vigorous physical activity, such as running at high speed or achieving explosive body movements, is considered essential in many sports, with the resulting risk of violent impacts to the head of a participating athlete, usually during collisions between athletes. This is especially true in sports such as American football, rugby, and soccer. Other sports, such as basketball, ice hockey, and baseball, involve the risk of violent impacts to the head of a participating athlete, either by the arm or leg movements of another athlete or by a piece of equipment, such as a baseball. These violent impacts can result in a brain injury, such as a concussion.

When such a violent impact occurs, the affected athlete sometimes exhibits symptoms that indicate the possible occurrence of such a brain injury. If such an injury has occurred, the athlete should not be allowed to return to the competition, as further injury is very likely. On the other hand, if such an injury has not actually occurred, it is often considered highly desirable for the athlete to return to the competition.

So, when an athlete suffers from a violent impact, the coaches, trainers, or team physicians often try to determine through subjective testing, in real-time, whether a brain injury such as a concussion has occurred. Such testing usually consists of asking the athlete questions or directly examining the athlete's reflex reactions and pupillary responses. Such crude testing is frequently inadequate to detect the incidence of an acute concussion, especially if subtle, and the athlete is often immediately returned to competition, with negative consequences for the athlete's health. The inadequacy of these testing methods varies at the different levels of the sport, with the greatest risk of inadequate subjective testing being at the lower amateur levels, because of the lower likelihood of qualified medical personnel being present. However, even at the professional level, the available methods are currently suboptimal.

Therefore, a reliable test is necessary which objectively assesses and documents the possible brain injury of an athlete, immediately after the possible occurrence of the injury, and in a short enough period of time to allow the athlete to return to the game if the objective testing indicates that no injury has occurred.

### BRIEF SUMMARY OF THE INVENTION

The present invention is a method and apparatus for objective testing of reduced cerebral function in athletes engaged in athletic competitions, where violent impacts to the head of an athlete can result in brain injury, such as a concussion. The test is ideally performed immediately after the occurrence of such an impact, such as on the sideline at a game, and a performance score is immediately given. This immediacy of the testing and the performance determination is referred to herein as “real-time”.

Athletes can be tested before a game begins, or before a season begins, to determine their personal baseline performance level, indicating a particular level of cerebral function. Multiple subjects can be tested, to determine a general or class baseline performance level. Athletes can also be tested prior to a competition to determine their general fitness to engage in the activity. Importantly, an athlete can then be tested immediately, during a game, if he or she is suspected of having suffered a violent impact to the head resulting in a brain injury. The athlete's real-time performance can then be compared immediately with the selected baseline performance data, in order to determine whether a reduced level of cerebral function is present, and whether the athlete can return to the game.

The test can be performed with a computer-controlled display and gaze tracking apparatus, with the display being adapted to be positioned in a fixed location with respect to the athlete's head, called herein a “head fixated” display. One type of such adaptation would be a head mounted display, such as goggles which are actually mounted directly to the head for testing. Other means of fixedly locating the display with respect to the head, without actually mounting the display to the head, could also be used. Some examples are a positioning arm or stand, next to which the head can be placed for testing, in order to fixedly locate the athlete's head in the desired position relative to a set of goggles, glasses, or other suitable eyepieces. Or, the positioning arm or stand could locate the athlete's head in the desired position relative to a computer screen. The goggles, glasses, eyepieces or computer screen can be mounted in a stationary fashion, such as on a desk, table, or tripod. Alternatively, the goggles, glasses, eyepieces or computer screen, as well as the associated computer, can be integrated into a small appliance, such as a box, that is adapted to be held in the hands of the athlete being tested, or in the hands of someone who is assisting the athlete in performing the test. What is important in these embodiments is that the eye or eyes of the test subject are located in a fixed position relative to the display being viewed by the test subject, such as a display in a set of goggles or a display on a computer screen. Fixedly locating the eyes of the test subject relative to the display enables the use of a gaze tracking device to determine exactly where on the display the test subject is directing his or her gaze.

Rather than using any of these “head-fixated” display schemes, the real-time test can be performed with the use of a computer with an interactive screen, such as a touch screen, which naturally does not use a gaze tracking device and therefore has no need for fixating the position of the head relative to the screen. For considerations of convenience and portability, the touch screen can be incorporated in a hand-held appliance such as a computer with a touch screen display. An example of such a device is the iPad® computer manufactured by Apple Inc.

Herein, the term “real-time” is used to refer to actions taken immediately after, or within minutes of, the possible sustaining of a brain concussion, rather than an hour or more later. The purpose of this distinction is to allow the present invention to be used to measure an athlete's icon tracking performance to determine whether a brain concussion has been sustained, with the screening being performed quickly enough after incidence of the possible injury to allow the athlete a realistic opportunity to return to the contest if no concussion has been inflicted. The term “baseline performance” refers to data previously collected relative to a given athlete, or relative to a group of test subjects. This baseline performance data provides a basis for determining, in real-time, the degree to which the icon tracking performance of that particular athlete indicates a reduction in cerebral function. Of course, an athlete also can be tested later, such as after a few hours, or days, as well as before the next game, if in fact a concussion has occurred or is strongly suspected, to determine whether that athlete's performance has returned to the “baseline performance” level.

Whether during initial testing to establish the baseline data or during real-time testing at an athletic competition, an icon is displayed for viewing by the athlete or other test subject, either in a head mounted display, or on a display being fixedly positioned in some other way with respect to the athlete's head, or on a touch screen display. The athlete or test subject is instructed to follow the movements of the icon with his or her eyes or touch, as closely and quickly as possible. When the touch screen is used, it may be touched with the athlete's finger or some other instrument.

The icon is moved from one location to another on the display, and the athlete's performance at following the icon is measured. Both the quickness with which the athlete responds and the accuracy of that response can be measured. The icon can be shown in one location, followed by disappearance of the icon and its appearance at a second location, repetitively moving to a plurality of different discrete locations on the display. In this mode, the athlete or other test subject tracks the successive discrete locations of the icon as quickly and accurately as possible. Alternatively, the icon can be continuously displayed, and moved around the display, and the athlete continuously tracks the location of the icon. The athlete or other test subject simply follows the icon with his or her eyes, or with his or her touch on the screen, and the athlete's performance is detected, either by a gaze tracking device in the display or by an interactive touch screen.

The real-time performance of the athlete is then compared with a baseline of data obtained in one of two ways. The baseline data can be data obtained by previous test performances by the same athlete, thereby comparing the athlete's level of cerebral function on a given day with his or her normal level. Or, the baseline data can be data obtained by test performances by one or more different test subjects, thereby comparing this particular athlete's real-time cerebral function with the cerebral function levels of the test subjects.

The baseline data can be used to establish a plurality of predetermined performance levels, with the lowest performance level being the most indicative of the presence of a brain injury and with the highest performance level being the most indicative of the absence of a brain injury. For example, if 10 performance levels are established, level 2 or 3 might be judged to indicate an unacceptable risk of the presence of a brain injury, while level 8 or 9 might be judged to indicate a very unlikely possibility of the presence of a brain injury. Naturally, the selection of a safe or unsafe performance level can be made by medical experts or other personnel, based on available information about brain injuries, the health and physical condition of the athletes in question, or any other background information determined to be germane by the appropriate authority. This performance level scheme can be employed whether the baseline data are compiled by previous testing of a plurality of test subjects or by previous testing of the particular athlete in question.

Testing equipment can be located at a game site, such as on the sideline or in the locker room. It can be linked to a local computer, or it can incorporate a hand-held computer in several of the embodiments. Alternatively, the test equipment can be linked to a central computer over the Internet, with the central computer performing all icon movements, detection and analyses of tracking performance, and comparison with baseline data.

The novel features of this invention, as well as the invention itself, will be best understood from the attached drawings, taken along with the following description, in which similar reference characters refer to similar parts, and in which:

### BRIEF DESCRIPTION OF THE SEVERAL VIEWS OF THE DRAWINGS

FIG. 1 is a schematic of a first embodiment of the present invention using a goggle type head mounted display;

FIG. 2 is a schematic of a second embodiment of the present invention using a table top type head fixated display;

FIG. 3 is a schematic showing the functioning of the embodiment shown in FIG. 1 according to the present invention;

FIG. 4 is a schematic of a third embodiment of the present invention using a touch screen display;

FIG. 5 shows various icon movement paths that may be employed with the present invention;

FIG. 6 illustrates the use of distraction icons with the present invention; and

FIG. 7 shows the concepts of the various baseline data bases.

### DETAILED DESCRIPTION OF THE INVENTION

The present invention measures the real-time level of cerebral function objectively, via a test protocol which can be individualized by comparing the real-time test results of an athlete against a pre-established baseline for that particular athlete. The real-time test performance of the athlete can also be objectively measured against pre-determined standards considered essential to a wider population of test subjects for safe participation in an athletic contest.

The images presented to the test subject, whether to a subject being tested to create baseline data, or to an athlete being tested in real-time, are designed for the test subject to follow with his or her eyes, or with his or her touch on a screen. The images thus presented, and to which the test subject's attention is directed, are designated herein as the “fixation icon.” The alertness test can employ either (1) a head fixated display or (2) a touch screen display.

Two types of “head fixated” displays are (1) a computer-controlled display actually mounted directly to the head of the test subject, or (2) a computer-controlled display having a means for fixedly locating the test subject's eyes at a particular position relative to a computer screen, a set of goggles, glasses, or other eyepieces. In the second type of head fixated display, the means for positioning the test subject's eyes relative to the screen can be mounted to a stationary element such as a table, or it can be held in the hands of the user or a test administrator. Any of these types of head fixated displays is fitted with a gaze tracking device. In any of the head fixated display embodiments, the test subject or athlete simply follows a moving icon with his or her eyes. Since eye movement is usually concomitant, meaning that both eyes move together, it is possible to use a head fixated display with only one eyepiece or goggle. Alternatively, of course, the test subject can view the display with both eyes, with only one eye being tracked by the gaze tracking device.

As mentioned above, alternatively to the head fixated display, the alertness test can employ a computer display having an interactive touch screen capability for receiving user input. Such a touch screen display can be incorporated in a hand-held computer, for example. The touch screen type of display need not be fitted with a gaze tracking device, because in this type of embodiment, the test subject or athlete simply follows a moving icon with his or her touch on the screen, such as with a finger or some other instrument.

In any of these embodiments, means is provided for computer control of the test protocols, including the movement or relocation of the fixation icon, and for computerized analyses of the test results. Software can compare the performance of the person being tested with baseline tests performed previously on the same subject, such as on a different day when the tested subject was at his or her normal level of cerebral function, establishing a “Personal Baseline Profile.” The individual's performance can also be compared with experimentally established baseline performance standards for a selected class of test subjects, establishing a “Class Baseline Profile.”

Expert systems, including but not limited to neural nets or rule based algorithms, can be employed to look for subtle degradations in real-time performance. Although these subtle degradations in performance in and of themselves may appear individually benign, when examined cumulatively over the length of the test, these can be a sign that the test subject's suitability for return to competition is in question. Performance standards can be developed to prevent athletes from engaging in competition if their score is below a minimum threshold which is considered safe. An inadequate performance score on the cerebral function test of the present invention, then, should preclude that athlete from engaging in competition, thereby safeguarding the health of the athlete.

These standards can be determined experimentally, either by repetitive testing of a given athlete, by having a statistically appropriate number of athletes who are engaged in the given type of sport perform the test, or by performing the test on a statistically appropriate number of members of the general population. Differences in performance between the baseline and the real-time test of an athlete are graded by the computer software, and a numerical score is provided, such as 6 on a scale of 10, or 4 on a scale of 10.

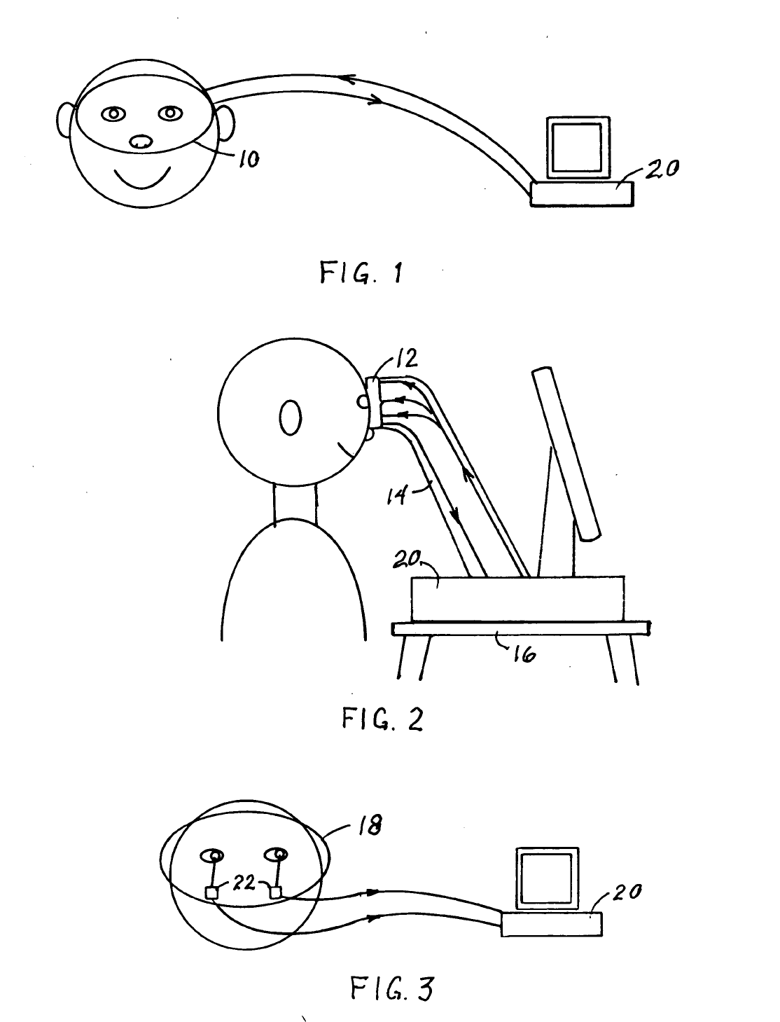

In the first two embodiments of the present invention discussed above, a “head fixated display” is used. This means a display device which remains in a fixed relationship with the head or eyes of the athlete being tested. A “head mounted display” is a first embodiment of a “head fixated display”, where the display is actually physically mounted to the head of the athlete. One example of a head mounted display is illustrated in FIG. 1. The display can be presented in any type of headgear 10, such as goggles or glasses or other suitable eyepieces worn by the test subject, where the head mounted display moves along with the head as the subject moves his or her head. The headgear 10 is connected to a computer 20 which controls the display and movement of a fixation icon, and which senses the gaze direction of the test subject's eyes, as discussed below.

Alternatively, as shown in FIG. 2, a second embodiment of a “head fixated display” can include an embodiment in which the display apparatus 12, similar to goggles, glasses, or other suitable eyepieces, is placed in a positioning structure 14 next to which the head of the test subject is placed. The display apparatus 12 can be eyewear having an integrated display, such as in the case of virtual reality goggles. Or, the display apparatus 12 can be a set of goggles, glasses, or other eyepieces designed simply to position the eyes of the test subject relative to a display screen, such as one which could be mounted to the top surface of the computer 20. FIG. 2 is drawn as a schematic representation of any of these alternatives. In any case, the display is electrically or electronically connected to the computer 20. A separate screen can be provided, as shown, for a test administrator who controls the administration of the test or reviews the test results. The apparatus 12 can be placed on any stable structure, such as on a table 16, on a counter, or on an independent stand such as a tripod. The display apparatus can also be small enough and light enough to be held in the hands of the test subject, or held in the hands of a test administrator. The key is that the eye positioning apparatus and the display screen must remain in a fixed relationship in order to enable the operation of the gaze tracking device. The computer can be incorporated into the display apparatus, whether table mounted or hand-held, or it can be separate from the display apparatus and electrically or electronically connected thereto, such as by a cable. In this type of head fixated display, the subject's head must not move significantly, relative to the display apparatus 12. The table-top type of head fixated display can have orientation adjustments to allow its comfortable alignment with the test subject's head. Both of the types of head fixated displays shown in FIGS. 1 and 2 employ the use of a gaze tracker to observe the test subject's eye movements, to determine how closely the test subject's gaze is fixed on the fixation icon.

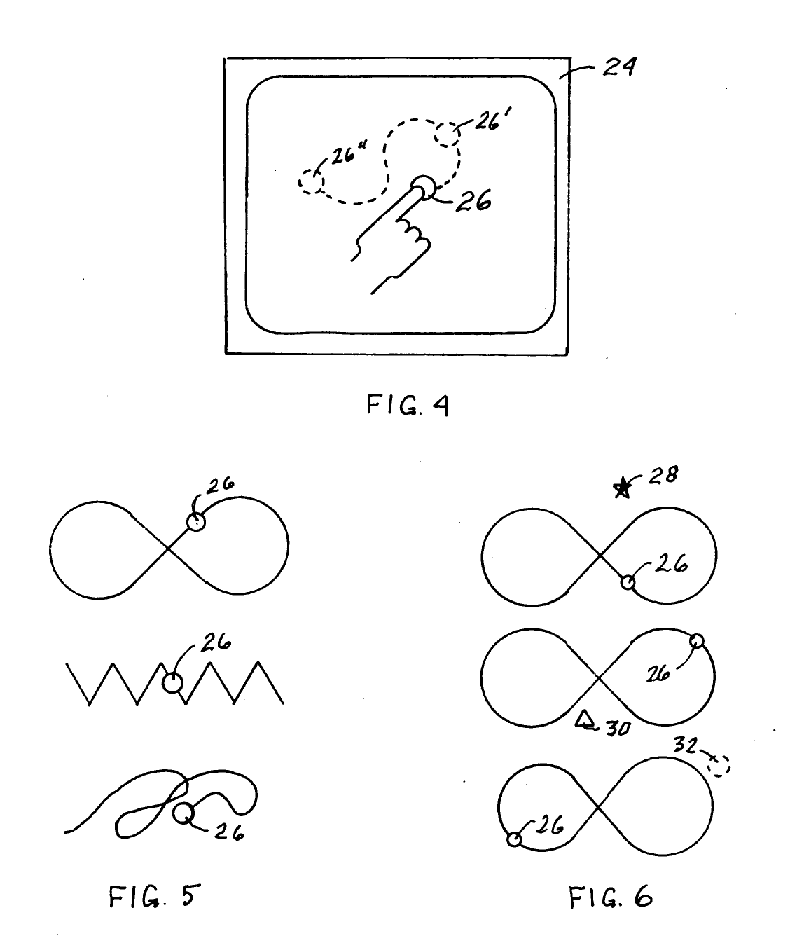

In a third embodiment of the present invention, having an interactive touch screen as shown in FIG. 4, the athlete attempts to use a finger, or some other instrument, to touch the screen at the location of the icon. In this embodiment, a gaze tracking device is not used, and it is not necessary to have the athlete's head fixedly positioned relative to the display.

The operation of the system, including presenting the fixation icon and directing its movement, supplying distraction images such as additional icons, performing data collection, and performing data analyses, are controlled by a suitable computer with custom software programs. If necessary, the refractive error of the subject can be compensated with appropriate lenses.

The test subject, using either of the first two embodiments of the present invention, is presented with visual images produced by the appropriate micro-display devices compatible with a head fixated display system, such as OLED displays, LCD displays, LED displays, retinal displays, etc. The present invention does not limit the display device used for these two embodiments, as long as it is functionally operative with a head fixated display system.

One possible display system for use in the two head fixated display embodiments is the Z800 3D Visor (from eMagin, Bellevue, Wash.), which uses a pair of eMagin SVGA OLED (organic light-emitting diode) micro-displays. These deliver high-speed, high-resolution (800×600 triad pixels), high-color (>16 million) images. OLED micro-displays are thinner and lighter than Liquid Crystal Displays (LCDs) and have higher luminance. The field of view is about 40 degrees (diagonal), corresponding to 32 and 24 degrees in the horizontal and vertical directions, respectively. The Z800 3D Visor is compatible with PCs that are capable of producing an analog SVGA resolution (800×600) with a refresh rate of 60 Hz. The Z800 was specifically designed to accommodate most forms of refractive eyewear.

The test subject, using the third embodiment of the present invention, is presented with visual images produced by a computer, preferably a hand-held computer, having any type of interactive touch screen display. Here again, the present invention does not limit the display device used for this third embodiment, as long as it is functionally operative as an interactive touch screen system.

One type of hand-held device having an interactive touch screen display for use in the third embodiment is the iPad® computer by Apple Inc.

A representative diagram of the functioning of the present invention, using a head mounted display configuration, is shown schematically in FIG. 3. The apparatus can employ a head mounted, virtual reality display 18. The display can be a three dimensional stereovision display. The instantaneous gaze direction of the test subject is measured via gaze trackers 22, which follow the movement of the subject's pupils (or other suitable gaze-tracking parameters) with high time resolution (typically 30 to 60 measurements per second). Thus, the gaze direction is followed in real time, measuring the detailed response to the dynamically varying fixation icon described herein. High quality gaze trackers allow subtle eye movements to be tracked, an important consideration in measuring levels of cerebral function.

As shown in FIG. 3, the head mounted display can employ two gaze-tracking devices 22 (typically consisting of a camera and infra-red illuminator) which are mounted, preferably at the bottom of the display 18. The position of the gaze tracker 22 with respect to the eye may be adjusted in the horizontal direction (linear motion) and in the vertical direction (rotation). The test subject's eyes are monitored with the gaze trackers, and erratic movements are processed by the computer 20. A permanent record is established. Eye movement “overshoots” and “undershoots” are of particular interest, as these indicate cerebral performance degradation which can be indicative of a brain injury, such as a concussion. The use of gaze tracking provides accurate correlation of the athlete's ability to visually follow the fixation icon. This is critical for objectivity, as it removes the subjective component related to an observer simply watching the eyes of the athlete who is suspected of having sustained a concussion.

An alternative embodiment is to employ a gaze tracker 22 for only one eye. Tracking only one eye relies on the fact that, in normal persons, eye movements of one eye correlate with eye movements of the fellow eye, i.e., the eyes move together.

The third embodiment of the present invention, as shown in FIG. 4, uses a computer with an interactive touch screen 24. A fixation icon 26 is presented on the computer monitor touch screen 24, similar to the presentation of a fixation icon on the displays of FIGS. 1 and 2. In the embodiment shown in FIG. 4, the athlete, wearing appropriate eyewear to compensate for any refractive error, manually tracks the fixation icon 26 with his or her finger or some other instrument. The touch screen 24 detects the athlete's touch, and the software of the system compares these touches with the actual movement of the fixation icon 26. Movement of the fixation icon 26 is represented by the dashed line in FIG. 4.

Regardless of whether a head fixated display or a touch screen display is used, a fixation icon 26, as seen in FIG. 4, can be continuously displayed along the path of movement. Alternatively, the fixation icon can be sequentially displayed at a series of discreet locations as represented by the circles 26, 26′, 26″ as shown, for example, in FIG. 4. The disappearance of the fixation icon 26 at one location can be followed instantaneously by the reappearance of the icon at another location, such as at 26′ or 26″. Alternatively, there can be a lag time between the disappearance of the fixation icon 26 at one location and the reappearance of the icon at another location. Deviations, such as faulty tracking, overshoots, and undershoots between the fixation icon movement and the subject's eye or touch movements indicate a reduction in cerebral function, such as can occur as a result of a concussion. Where the icon 26 is sequentially displayed in a plurality of discrete locations, the test subject's tracking of the icon is by a sequential series of eye fixations, or a sequential series of touch points, at the sequential locations where the icon 26 appears. Where the icon 26 is continuously displayed, the test subject tracks the position of the icon 26 continuously, either with the eyes or by touch, as it moves around the display.

The fixation icon can be presented to the test subject in black and white, such as a black icon against a white background, or the reverse, or in chosen colors, with one example being red on green, or green on red, and another being yellow on blue, or blue on yellow. The fixation icon, as directed by the computer, can move at a constant speed, or at varying speeds, and can also be directed to halt movement altogether at any designated time. The fixation icon can dynamically vary in size and shape. As shown in FIG. 5, the fixation icon 26 can travel in many different patterns, including a “figure-of-eight” pattern, in a “w” pattern, in any other pattern, or randomly, i.e., the present invention does not contemplate limits on the motion, the speed, or the dynamic variation of the fixation icon 26.

The test subject is told to constantly track the appropriate icon 26 regardless of its motion or lack of motion, or speed of motion. For instance, the icon 26 may move to the left, to the right, diagonally, or randomly, and at a constant speed, or at different speeds. The icon 26 may appear to the test subject to come closer or go further away. The icon 26 may also become harder to visualize, because the intensity of either the icon itself or the background may change. Additionally, “distraction” icons, as shown in FIG. 6, may be presented to test how well the test subject maintains tracking ability when presented with visual distractions. For example, in FIG. 6, where the fixation icon 26 is a solid circle traveling in a “figure eight”, distraction icons can be presented as a star 28, as shown in the first view, a triangle 30, as shown in the second view, or a dashed or flashing circle 32, as shown in the third view. Any other type of distraction icon may also be used. Distracting sounds of various sorts can also be presented to the test subject via earphones or external speakers. These sounds can be used as part of a “confusion” environment designed to test the subject's level of cerebral function. Subjects who have sustained a brain injury have much greater difficulty following the fixation icon 26 if distracting elements, both visual and auditory, are presented.

The speed of the moving icon is very important as a measurement of cerebral function. Injured subjects have a difficult time following a fast-moving target, especially if that target changes direction quickly. As an example; if a fixation icon is moving to the left and then suddenly and without warning moves back to the right, a subject with a cerebral function deficit tends to keep tracking to the left and will temporarily lose fixation of the icon, since it has now moved to the right. The subject then begins to search for the fixation icon.

All of these eye or touch movements, and the cohesiveness and the smoothness noted, are recorded onto the computer for analyses. Of course, even an uninjured “high-performance” test subject will make a certain number of tracking mistakes. What is important is how many mistakes are made, whether these are subtle or gross, and the frequency with which they occur. This information enters the computer, where it is analyzed and compared with the baseline data. This baseline data can include pre-established background data for the specific athlete being tested, the typical performances of other individuals who engage in the same activity, or the typical performance of other individuals in the general population.

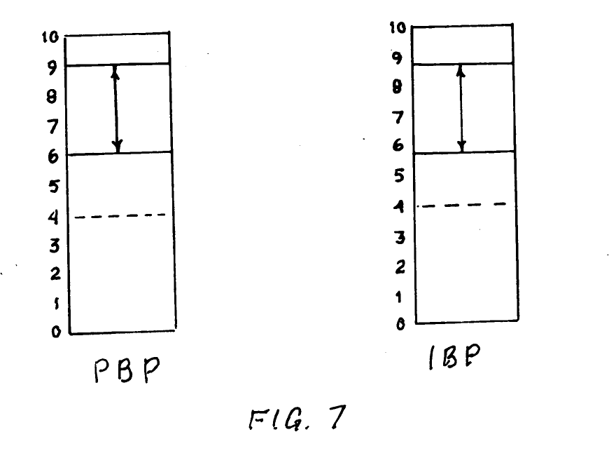

Deviations related to inability of the test subject to properly track the fixation icon are analyzed by the computer software and compared with the Personal Baseline Profile PBP of the subject in question, and, in addition or in the alternative, these deviations can be compared with the Class Baseline Profile CBP, both of which are conceptually illustrated in FIG. 7. The Personal Baseline Profile is established by comparing the performance of the athlete being tested with baseline tests performed previously on the same athlete, such as on different days when the tested athlete was completely free of the effects of any brain injury, or before the season begins. The Class Baseline Profile is established by collecting and analyzing the performances of a statistically significant number of test subjects who engage in the same activity. For example, for real-time testing of a football player, the Class Baseline Profile might be established by testing only football players, or by testing only players in sports such as football, rugby, or soccer. Alternatively, the Class Baseline Profile might be established by testing only subjects who engage in sports. As another alternative, the Class Baseline Profile can be established by collecting and analyzing the performances of a statistically significant number of test subjects from the general population.

Faulty real-time performance of the testing according to the present invention, demonstrating a significant deficit in cerebral function, should result in preventing the athlete from returning to competition on the day in question. Although the ability to track a given fixation icon tends to vary from person to person, for an individual subject, the test results on different occasions tend to be quite similar for a particular level of cerebral function. When a number of test results have been obtained for a particular athlete during a state of good health, including before the season begins, this composite profile constitutes that subject's Personal Baseline Profile. When the athlete has suffered a concussion, however, the test results are degraded relative to the subject's Personal Baseline Profile, as well as relative to the Class Baseline Profile.

The following example shows one way the method and apparatus of the present invention can be employed. Assume that a football player is engaged in a game. That athlete's Personal Baseline Profile database, as shown in FIG. 7, has been established in advance. Assume that the athlete's normal performance level on the test is in the range of 6 to 9 on a scale of 10, as shown by the range between the solid horizontal lines in this particular athlete's Personal Baseline Profile in FIG. 7. Also assume that the normal performance level of all football players on the test is 5.75 to 8.75 on a scale of 10, as shown by the range between the solid horizontal lines in the Class Baseline Profile, in FIG. 7. If the player receives a violent blow to the head, particularly one which seems to reduce the player's coordination or level of awareness, the player is immediately asked to perform a test according to the present invention, using test equipment located either on the sideline or in the locker room. If a real-time deficit is noted, as compared with the player's Personal Baseline Profile, or as compared with the Class Baseline Profile, it is advisable that the player not be allowed to return to the game. Assume that in real-time, the player scores a 4, as shown by the horizontal dashed lines in FIG. 7. This score is well below the player's Personal Baseline Profile range of 6 to 9, and it is well below the Class Baseline Profile range of 5.75 to 8.75. The player should probably be removed from competition until further testing or treatment can be provided. If the athlete scores a sufficiently high performance level to indicate that no brain injury has occurred, he can be cleared to return to the game. Alternatively, for safety, the athlete could be rechecked again after a few minutes, before returning to the game. Further, if a player is frequently in a reduced state of cerebral function, as documented by comparing the Personal Baseline Profile to the Class Baseline Profile, and by noting chronic deficiencies, the player probably should not continue playing football. As with all of the examples given here, the actions to be taken as a result of the achievement of a given score should be established by the authorities who are responsible for the particular player or the particular type of sport in which the player is engaged.

In performance of the test according to the present invention, the overall level of cerebral function is being tested. In addition to being caused by a brain injury, any real-time deficit in cerebral function that is detected, as compared to the athlete's personal baseline data, may derive from intoxication or some other transient condition. The test administered according to the present invention is oriented toward measuring a level of overall cerebral function, so it may not distinguish these factors from a real-time brain injury. Nevertheless, a reduced level of performance on the test, whatever the underlying cause, can indicate a likelihood of a reduced level of safety for the athlete. So, a reduced level of performance can still be a valid reason for removing a player from competition.

When a performance deficit is noted, as compared to the class baseline data, chronic vision problems, or even a chronic deficit in the operator's mental acuity could be the cause. However, this situation will be discovered upon testing to establish the athlete's personal baseline data, and taken into account, so that it will not be a factor in making real-time decisions on whether an athlete can return to a game.

While the particular invention as herein shown and disclosed in detail is fully capable of obtaining the objects and providing the advantages hereinbefore stated, it is to be understood that this disclosure is merely illustrative of the presently preferred embodiments of the invention and that no limitations are intended other than as described in the appended claims.

I claim:

1. A method for real-time screening of an athlete for a reduction in cerebral function resulting from a brain concussion, said method comprising:
providing a display, a user input device, and an associated computer;
displaying a movable icon on said display, for viewing by an athlete suspected of having sustained a brain concussion;
sequentially altering the location of said icon on said display, under control of said computer, as said athlete attempts to follow said location of said icon;
detecting, with said user input device, said athlete's attempted following of said icon;
analyzing, with said computer, said athlete's real-time performance at following said icon;
comparing said real-time performance with a previously established baseline performance; and
determining, with said computer, whether said athlete's real-time performance exhibits a reduced level of cerebral function indicating the incidence of a brain concussion.

2. The method recited in claim 1, wherein:
said user input device comprises a gaze tracking device associated with said display;
said movable icon comprises a gaze fixation icon;
said athlete's attempted following of said icon comprises fixation of said athlete's gaze upon said icon;
said detection of said athlete's attempted following of said icon comprises detecting, with said gaze tracking device, the direction of said athlete's gaze; and
said analysis of said athlete's real-time performance at following said icon comprises analyzing said athlete's real-time performance at directing said athlete's gaze at said icon.

3. The method recited in claim 2, further comprising positioning said display in a fixed relationship to the head of said athlete.

4. The method recited in claim 3, further comprising mounting said display to the head of said athlete, said display being free to move with the head of said athlete.

5. The method recited in claim 3, further comprising positioning the head of said athlete in close proximity to a positioning apparatus, said positioning apparatus remaining in a fixed position relative to said display.

6. The method recited in claim 1, wherein:
said display comprises an interactive touch screen, constituting said user input device;
said athlete's attempted following of said icon comprises following said icon with said athlete's touch on said touch screen;
said detection of said athlete's attempted following of said icon comprises detecting, with said touch screen, the location of said athlete's touch on said touch screen; and
said analysis of said athlete's real-time performance at following said icon comprises analyzing said athlete's real-time performance at touching said touch screen at the location of said icon.

7. The method recited in claim 1, wherein said alteration of the location of said icon further comprises:
sequentially displaying said icon at a plurality of discreet locations on said display; and
removing said icon from said display between said displays of said icon at said plurality of discreet locations.

8. The method recited in claim 7, wherein said analysis of said athlete's real-time performance further comprises measuring the elapsed time between each reappearance of said icon and said athlete's location of said icon after each said reappearance.

9. The method recited in claim 7, wherein said analysis of said athlete's real-time performance further comprises measuring the accuracy of said athlete's location of said icon after each said reappearance.

10. The method recited in claim 1, wherein said alteration of the location of said icon further comprises continuously displaying said icon during movement of said icon around said display.

11. The method recited in claim 10, further comprising measuring how closely said athlete follows said movement of said icon around said display.

12. The method recited in claim 1, further comprising establishment of said previously established baseline performance by a method comprising:
providing a display, a user input device, and an associated computer;
displaying a movable icon on said display, for viewing by at least one test subject;
sequentially altering the location of said icon on said display, under control of said computer, as said test subject attempts to follow said icon;
detecting, with said user input device, said test subject's attempted following of said icon; and
analyzing, with said computer, said test subject's performance at following said icon to thereby establish said baseline performance.

13. The method recited in claim 12, wherein said at least one test subject and said athlete suspected of having sustained a brain concussion are the same person.

14. The method recited in claim 12, wherein said at least one test subject comprises a plurality of test subjects.

15. The method recited in claim 1, further comprising establishing a plurality of discreet performance levels, constituting said baseline performance, said plurality of discreet performance levels ranging from a lowest performance level indicating the most likelihood of the presence of a brain concussion to a highest performance level indicating the least likelihood of the presence of a brain concussion.

16. The method recited in claim 15, wherein said determination of whether said athlete's real-time performance exhibits a reduced level of cerebral function indicating the incidence of a brain concussion comprises:
assigning said athlete's real-time performance to one of said discreet performance levels; and
comparing said athlete's real-time performance level with a performance level previously established for said athlete.

17. The method recited in claim 15, wherein said determination of whether said athlete's real-time performance exhibits a reduced level of cerebral function indicating the incidence of a brain concussion comprises:
assigning said athlete's real-time performance to one of said discreet performance levels; and
comparing said athlete's real-time performance level with a performance level previously established as a minimum satisfactory performance level.

18. An apparatus for real-time testing of the cerebral function of an athlete suspected of having sustained a brain concussion, comprising:
a computerized display, said display being adapted to display an icon for viewing by said athlete;
a computer adapted to move said icon around said display; and
a gaze tracking device on said display adapted to detect the direction of said athlete's gaze;
said computer being programmed to:
detect, with said gaze tracking device, the direction of said athlete's gaze relative to the location of said icon;
analyze, in real-time, said athlete's performance at directing said athlete's gaze at said icon; and
determine, in real-time, whether said athlete's real-time performance indicates a reduced level of cerebral function indicating the incidence of a brain concussion.

19. The apparatus recited in claim 18, wherein said display is further adapted to be positioned in a fixed relationship to the head of said athlete.

20. An apparatus for real-time testing of the cerebral function of an athlete suspected of having sustained a brain concussion, comprising:
a computerized interactive touch screen, said touch screen being adapted to display an icon for viewing by said athlete; and
a computer adapted to move said icon around said touch screen;
said computer being programmed to:
detect the location of said athlete's touch on said touch screen relative to the location of said icon on said touch screen;
analyze, in real-time, said athlete's performance at following said icon with said athlete's touch on said touch screen; and
determine, in real-time, whether said athlete's real-time performance indicates a reduced level of cerebral function indicating the incidence of a brain concussion.
